(19) United States
(12) Patent Application Publication
(10) Pub. No.: US 2026/0336496 A1
(43) Pub. Date: Oct. 29, 2026

(54) MODULAR VEHICLE INTERIOR SYSTEM

(71) Applicant: Faurecia Interior Systems USA Holdings, LLC, Auburn Hills, MI (US)

(72) Inventors: Thomas DESSAPT, Auburn Hills, MI (US); Cédric KETELS, White Lake, MI (US); Benjamin LOUIS, Bloomfield Hills, MI (US); Shibo WANG, Rochester Hills, MI (US)

(21) Appl. No.: 19/186,914

(22) Filed: Apr. 23, 2025

(51) Int. Cl. B60N 3/00; B60K 35/60; B60N 2/28; B60N 3/10

(52) U.S. Cl. CPC B60N 3/002; B60K 35/60; B60N 2/2887; B60N 3/104

(57) ABSTRACT

A vehicle interior system includes a base and various modules that are removably attachable to the base at a plurality of locations arranged longitudinally along the inside of a vehicle passenger cabin. The modules include interchangeable console and seat cushion modules along with various interchangeable accessory modules that are removably attachable at different locations than the console and seat cushion modules. The modules may be powered modules that are connected with the vehicle electrical system via the base. The system provides versatility for a variety of use cases and helps optimize use of the volume of the passenger cabin, particularly along a midline of the cabin.

### TECHNICAL FIELD

The present disclosure is related to reconfigurable vehicle interiors.

### BACKGROUND

Vehicle interior systems commonly include a center console located in a fixed position between two seats in a first row of seats. In some cases, the center console module may be moveable to a different location. In one example, US 2008/0303302 discloses a console able to slide forward and backward along a track in a passenger seating area of the vehicle between the first row of seats and a second row of seats. However, such a console has limited versatility with regard to efficient use of vehicle interior volume.

### SUMMARY

Embodiments of a vehicle interior system include a base extending longitudinally in a vehicle passenger cabin and a console module that is removably attachable to the base at a first location in a first row of seats and to a seat frame at a second location in a second row of seats.

In various embodiments, the vehicle interior system includes a seat cushion module that is removably attachable to the base at the first location and to the seat frame at the second location.

In various embodiments, a seat cushion module is configured to be attached to the base at the first location in a forward configuration and in a backward configuration.

In various embodiments, the base includes a tunnel formed from at least one wall. The tunnel at least partly defines a longitudinal passage between a first seat of the first row of seats and a second seat of the first row of seats.

In various embodiments, the first location is on top of a tunnel of the base.

In various embodiments, the base includes a first mating surface at the first location, and the seat frame includes a second mating surface at the second location. The first mating surface and the second mating surface have different contours. Portions of the first and second mating surfaces may be the same.

In various embodiments, a mating surface at one of the first and second locations includes an upstanding ledge that a mating surface of the other of the first and second locations does not have. A base of the console module has a cutout that accommodates the ledge.

In various embodiments, the vehicle interior system includes an accessory module that is removably attachable to the base at a third location forward of the first location and removably attachable to the base at a fourth location between the first and second locations.

In various embodiments, front and rear ends of an accessory module are configured to be supported by respective front and rear supports at each of the third and fourth locations.

In various embodiments, an end of an accessory module is magnetically attachable to the base at the third location and magnetically attachable to the base at the fourth location. The end of the accessory module may be a rear end when installed at the third location and a front end when installed at the fourth location.

In various embodiments, an accessory module is one of a plurality of accessory modules each having a different function and each being interchangeable with each other at each of the third at fourth locations.

In various embodiments, the base is configured to power installed modules via a concealed electrical connection.

In various embodiments, the base includes child safety seat anchors at the first location.

In various embodiments, the base includes a rear portion with a tunnel abutting a rear wall of the vehicle passenger cabin, the tunnel having a passage that provides access to the vehicle passenger cabin from a rear vehicle storage area.

In various embodiments, the console module includes an extendable and retractable working surface.

In various embodiments, the base extends along a floor of the vehicle passenger cabin between an instrument panel located at a front of the vehicle passenger cabin and a rear of the vehicle passenger cabin located behind the second row of seats.

Embodiments of the vehicle interior system include a base extending between separate first and second seats of a front row of seats in a vehicle passenger cabin and a seat cushion module removably attachable to the base at a location between the first and second seats and in the front row of seats. The base includes anchors rearward of said location, and the anchors are configured for securing a rear-facing child safety on the seat cushion module in the front row of seats.

It is intended that any one or more of the above-listed features, along with any of the features in the figures and in the following description, can be combined in any technically feasible combination to define a claimed invention, except where features are mutually exclusive.

### BRIEF DESCRIPTION OF THE DRAWINGS

Illustrative embodiments will hereinafter be described in conjunction with the following figures, wherein like numerals denote like elements, and wherein:

FIG. 1 is a perspective side view of an example of a vehicle interior system installed in a vehicle passenger cabin;

FIG. 2 is a perspective view of the base of the vehicle interior system of FIG. 1;

FIG. 3 is a perspective side view of the console module of FIG. 1 installed at a first location;

FIG. 4 is a perspective side view of the console module of FIG. 3 installed at a second location;

FIG. 5 is a perspective view side of the seat cushion module of FIG. 1 installed at the second location of FIG. 4;

FIG. 6 is a perspective side view of the seat cushion module of FIG. 5 installed at the first location of FIG. 3;

FIG. 7 is a perspective side view of the seat cushion module of FIG. 6 installed at the first location in a backward configuration;

FIG. 8 is a side view of the vehicle interior system of FIG. 1 with two accessory modules installed;

FIG. 9 is the side view of FIG. 8 with the accessory modules locations switched;

FIG. 10 is a perspective view of a storage bin module during installation;

FIG. 11 is a perspective view of an insulated storage module during installation;

FIG. 12 is a perspective view of an installed frame module;

FIG. 13 is a side view of a refuse module during installation;

FIG. 14 is a perspective view of a powered holder module;

FIG. 15 is an enlarged perspective view of an accessory module protrusion configured to mate with a receptacle when the module is installed;

FIG. 16 is an enlarged perspective view of a receptacle configured receive a protrusion of an accessory module;

FIG. 17 is a cross-sectional view taken from FIG. 8;

FIG. 18 is a perspective view of the inside of a vehicle passenger cabin equipped with the interior system of FIG. 1 showing a working surface extending from the console module;

FIG. 19 is a perspective view of the inside of the vehicle passenger cabin of FIG. 1 with the interior system configured to accommodate extra-long cargo;

FIG. 20 is a perspective side view of the interior system configured as in FIG. 19;

FIG. 21 is a perspective view of the inside of a vehicle passenger cabin with the interior system configured to secure a child-safety seat in the first row of seats;

FIG. 22 is a perspective side view of the interior system configured as in FIG. 21;

FIG. 23 is a perspective view of the inside of a vehicle passenger in which the interior system has a seat cushion module in the first row of seats and a console module with a deployable working surface in the second rows of seats;

FIG. 24 is a perspective side view of the interior system configured as in FIG. 23;

FIG. 25 is a perspective view of the inside of a vehicle passenger in which the interior system has two accessory modules installed;

FIG. 26 is a perspective side view of the interior system configured as in FIG. 25;

FIG. 27 is a perspective view of the inside of a vehicle passenger in which the interior system has a seat cushion module in the first row of seats and a console module in the second rows of seats;

FIG. 28 is a perspective side view of the interior system configured as in FIG. 27;

FIG. 29 is a perspective view of the inside of a vehicle passenger in which the second row of seats is folded too accommodate large cargo secured to the base of the system;

FIG. 30 is a perspective side view of the interior system configured as in FIG. 29;

FIG. 31 is a perspective view of the inside of a vehicle passenger in which console modules are installed in the first and second row of seats; and

FIG. 32 is a perspective side view of the interior system configured as in FIG. 31;

### DESCRIPTION OF ILLUSTATIVE EMBODIMENTS

Described herein is a modular vehicle interior system for use in a vehicle passenger cabin. The system includes one or more modules with different functions that can be removably attached at multiple locations along the system in the passenger cabin. Multiple different interchangeable modules may be provided to allow vehicle occupants to customize the functions available in different portions of the cabin, to provide unconventional interior system configurations, and to more efficiently use the interior volume of the cabin.

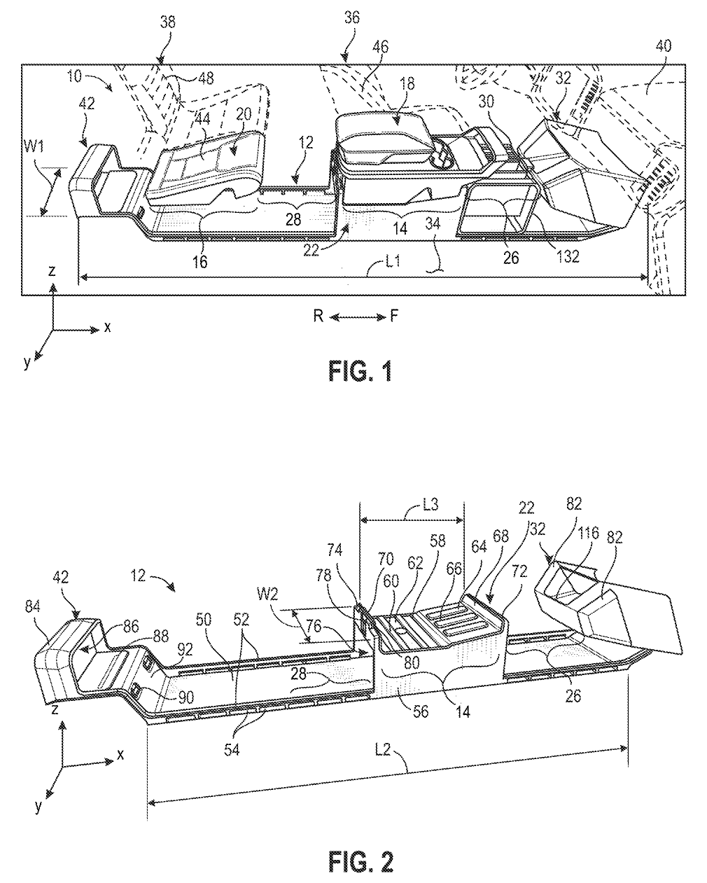

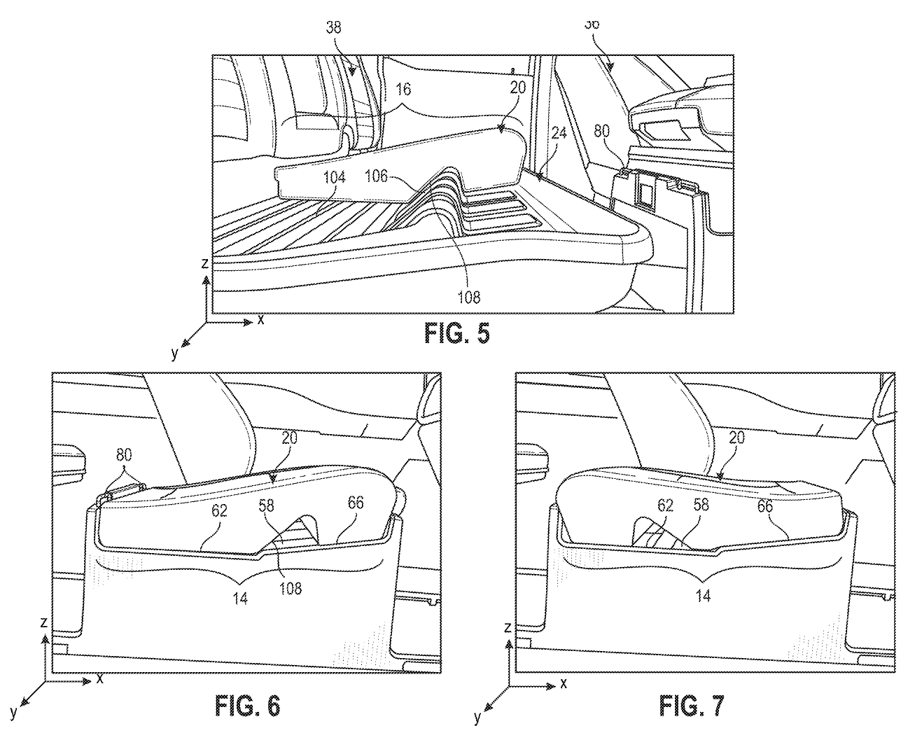

FIG. 1 is a perspective view of an example of a vehicle interior system 10 installed in the passenger cabin of a vehicle. The system 10 is modular and includes a base 12 defining a first location 14 for attachment of a module, a second location 16 rearward of the first location for attachment of the same or a different module, and one or more removably attachable modules 18, 20 that are interchangeable between the locations. The system 10 is illustrated in FIG. 1 with a console module 18 installed on the base 12 at the first location 14, atop a tunnel 22 of the base, and a seat cushion module 20 installed on a seat frame 24 (FIG. 5) at the second location 16. The illustrated system 10 includes third and fourth locations 26, 28 along the base 12 configured to receive any of a plurality of different types of accessory modules 30, such as the illustrated file organizer module. At the third location 26, each accessory module 26 is supported at the front of the tunnel 22 and a front portion 32 of the base 12. At the fourth location 28, each accessory module 26 is supported at the rear of the tunnel 22 and the seat frame 24.

The illustrated system 10 is configured for supporting two primary modules—here, the console module 18 and the seat cushion module 20—along with two accessory modules 30 adjacent the tunnel 22 and vertically below the primary modules. Longitudinal (x) dimensions of the accessory modules 30 and their associated attachment locations 26, 28 may be less than or otherwise different from longitudinal dimensions of the primary modules 18, 20 and their associated attachment locations 14, 16 such that the primary and accessory modules are not interchangeable with each other within the system 10. The multiple locations 14, 16, 26, 28 at which modules can be installed may be discrete locations—i.e., each location is at a fixed longitudinal position of the system 10 such that the modules cannot be positioned anywhere between the designated locations as might be possible with a sliding-type system. As illustrated, the longitudinal direction (x) is aligned with the forward (F) and rearward (R) directions of the vehicle, and a transverse direction (y) extends in the side-to-side direction of the vehicle. The longitudinal and transverse directions (x, y) are perpendicular to each other and to a vertical direction (z).

The base 12 may be a permanently installed feature of the system 10 that extends longitudinally in the vehicle passenger cabin. The base 12 may extend along a floor 34 of the vehicle passenger cabin between a front of the vehicle passenger cabin, forward of a first row 36 of seats, and a rear of the vehicle passenger cabin rearward of a second row 38 of seats. In this example, the base 10 lies along a midline of the vehicle passenger cabin that divides the cabin into left and right halves. The front portion 32 of the base 12 abuts an instrument panel 40 of the vehicle, and a rear portion 42 of the base is behind the seat frame 24 of a center seat 44 of the second row 38 of seats. The rear portion 42 of the base 12 may be aligned with a backrest of the center seat 44 of the second row 38 of seats. In some cases, the rear portion 42 of the base 12 may be fully behind the center seat 44 of the second row 38 of seats. The passenger side seats of the first and second rows 36, 38 are omitted in FIG. 1, as is the backrest of the center seat 44. The base 12 has a width W1 sized to fit between a first seat 46 and a second seat of the first row 36 of seats and may extend an entire length L1 of the vehicle passenger cabin as shown. The illustrated base 12 extends longitudinally between a first seat 48 and a second seat of the second row 38 of seats. The illustrated base 12 also extends under the second row 38 of seats. In some embodiments, the base 12 extends between first and second seats of a third row of seats. In another example, the tunnel 22 is the front portion of the base 12. The illustrated front portion 32 may for example be an integral part of the instrument panel 40 rather than part of the base 12. In another example, the tunnel 22 and first location 14 may be located between seats of the second row 38 of seats with the second location 16 between seats of a third row. It is also possible that at least a portion of the base 12 is elevated above the floor 34 of the passenger cabin.

In a specific embodiment, the vehicle is a pick-up truck with first and second rows 36, 38 of seats, and the second row of seats is adjacent a rear wall of the passenger cabin such that the rear portion 42 of the base 12 abuts the rear wall. The seats of the second row 38 may be part of a bench seat assembly or a split-bench seat assembly in which the seat bottom portion is configured to fold upward to lie against a backrest portion when not in use by a vehicle occupant. As used herein a “seat” of the vehicle is a structure or part of a structure intended for a single vehicle occupant to sit in the passenger cabin such that a bench seat assembly or split-bench seat assembly spanning the width of the vehicle includes has seats, including the center seat 44 between the first seat 48 and second seat of the row 38.

FIG. 2 is a perspective view of the base 12 of the vehicle interior system 10 of FIG. 1 without any modules installed. The base 12 includes a bottom 50 extending between the front portion 32 and the rear portion 42 and configured to lie along the floor 34 of the passenger cabin. The bottom 50 is generally flat with longitudinally extending ridges 52 along its opposite transverse sides. A plurality of openings 54 is formed through the ridges 52 of the bottom 50 of the base 12. The plurality of openings 54 may be located along a length L2 of the bottom 50 the base 12. Openings 54 formed through transversely opposite ridges 52 of the bottom 50 may be aligned with each other. In this example, the openings 54 are slots included along the entire length L2 of the bottom 50 of base 12 except at the tunnel 22. The openings 54 may be used to strap down cargo during transportation in the first or second row 36, 38 of seats, such as when the bottom portion of the second row 38 of seats is folded up and/or when no accessory module 30 is installed at the third or fourth module location 28.

The tunnel 22 extends upward from the bottom 50 and is formed by at least one wall 56 extending from the bottom. In this case, the tunnel 22 includes two transversely spaced vertical side walls interconnected by a transversely extending top wall that provides a first mating surface 58 at the first module location 14. The first mating surface 58 is shaped to receive each of the primary modules 18, 20—i.e., at least a portion of the mating surface 58 is complementary in contour with a mating surface along the bottom of each primary module. For example, the mating surface 58 of FIG. 2 has a series of transverse ridges 60 on a horizontal portion 62 of the surface and a series of longitudinal ridges 64 on an inclined portion 66 of the surface forward of the horizontal portion. These ridges 60, 64 may be configured to fit between corresponding ridges on the bottom of each primary module. The mating surface 58 also includes front and rear vertically extending portions 68, 70 facing each other across the top of the tunnel 22. The vertically extending portions 68, 70 of the mating surface 58 are provided by front and rear lips 72, 74 extending transversely along the front and rear ends of the tunnel 22. The lips 72, 74 can constrain longitudinal movement of an installed module. The length L3 and width W2 of the mating surface 58 may be the same as the corresponding length and width of the base or bottom of each primary module.

The tunnel 22 at least partly defines a longitudinal passage 76 between the seats of the first row 36 of seats that connects a space forward of the front row of seats with a space rearward of the front row of seats—i.e., the tunnel 22 is open at both longitudinal ends. The longitudinal passage 76 may be a continuous, open space below the first mating surface 58 that is delimited by the tunnel 22 and a portion of the bottom 50 of the base 12 beneath the tunnel such that the base completely surrounds the passage. The passage 76 may advantageously provide space for longer cargo (e.g., skis, fishing rods, lumber, etc.) in certain configurations of the system 10.

The base 12 also includes receptacles 78 at opposite longitudinal ends of the tunnel 22, each configured to receive one end of an accessory module 30 for attachment to the base 12. One receptacle 78 is provided along a rear face of the rear lip 74, and the other receptacle (not visible in FIG. 2) is provided on along a front face of the front lip 72 facing in the opposite direction. The base 12 also includes a pair of transversely spaced anchors 80 along the rear lip 74 and/or tunnel 22 that can be configured for securing a child safety seat or other cargo. The anchors 80 may comply with Isofix standards (ISO 13216 or its national equivalents, derivatives, or future replacement standard). These features are discussed in conjunction with subsequent figures.

The front portion 32 of the base 12 may include one or more storage areas. The illustrated example includes a pair of safes 82 located at the front of the vehicle passenger cabin, one being accessible from the first seat and one being accessible from the second seat of the front row of seats. Each safe 82 is a lockable storage area with limited access provided to someone having a key or other unique identifier indicating the possessor is permitted to access the storage area. These storage areas may alternatively provide unlimited access with a conventional latch. The front portion 32 of the illustrated base 12 also includes an open storage bin between the pair of safes 82.

The rear portion 42 of the base 12 includes another tunnel 84 defining another longitudinal passage 86. The rear tunnel 84 may be located below a backrest of the center seat 44 of the second row 38 of seats such that the passage 86 interconnects a space in the second row of seats with a storage area behind the second row of seats. The rear portion 42 may further include a door 88 that is movable between an open position (e.g., pivoted down as shown) and closed position (e.g., pivoted up) to selectively close off the passage 86. As illustrated in subsequent figures, the passage 86 may be used to transport long objects (e.g., lumber, pipes, etc.) that would otherwise need to be transported on the exterior of the vehicle. The illustrated base 12 includes an additional set of anchors 90 affixed to a wall 92 of the base that connects the bottom 50 with the rear portion 42 of the base. The anchors 90 may be metal and/or pivoting anchors and are useful for securing cargo in the passenger cabin.

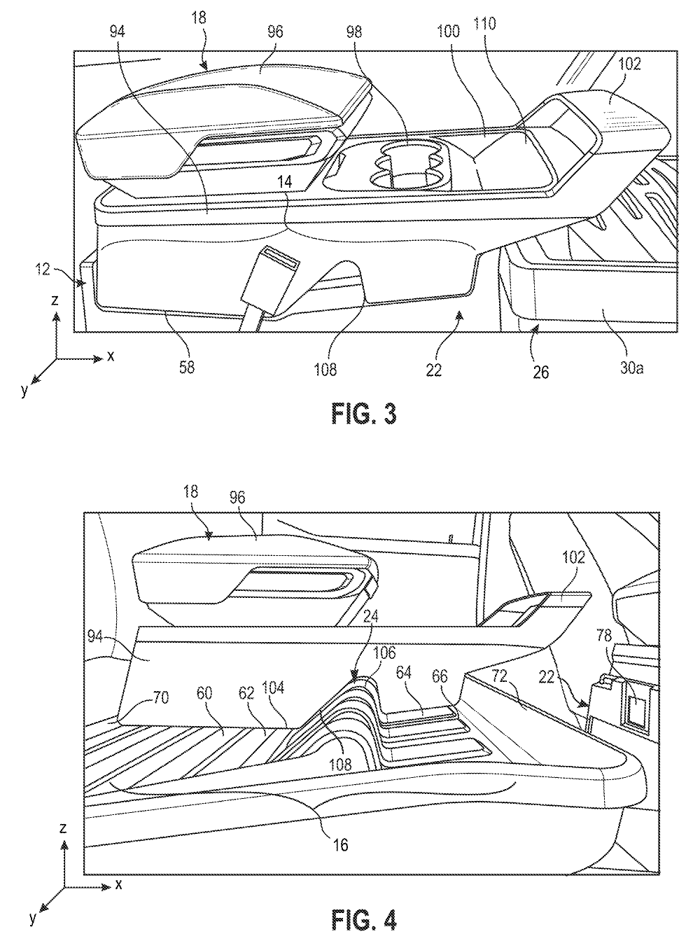

FIGS. 3 and 4 are enlarged views of the console module 18 of FIG. 1 removably attached to the base 12 at the first location 14 in the first row 36 of seats (FIG. 3) and removably attached to the seat frame 24 at the second location 16 in the second row 38 of seats (FIG. 4). The second seat of each row of seats is omitted in FIGS. 3 and 4. The console module 18 may serve as an armrest to passengers in the row of seats where it is installed and may provide an area to store personal belongings during use of the vehicle. The illustrated console module 18 includes a base 94, an armrest 96 atop the base, cupholders 98 forward of the armrest, a cavity 100 forward of the cupholders, and a handle 102 forward of the cavity. While not shown explicitly, the base 94 of the console module 18 may include an electrical connector that mates with an electrical connector located along the mating surface 58 on top of the tunnel 22 when the module is installed at the first location 14 such that the console module is a powered module connected with a vehicle power source.

At least a portion of the bottom surface of the base 94 is complementary in shape with the first mating surface 58 at the first location 14 and with a second mating surface 104 at the second location 16. As shown in FIG. 4, the second mating surface 104 has several features in common with the first mating surface 58 described in conjunction with FIG. 2, including a horizontal portion 62, inclined portion 66, vertically extending portions 68, 70, and transverse and longitudinal ridges 60, 64. One vertically extending portion 68 is provided by a transversely extending lip 72 of the seat frame 24. The second mating surface 104 also has a portion between the horizontal and inclined portions 62, 66 provided by an upstanding ledge 106 of the seat frame 24. The first and second mating surfaces 58, 104 thus have different contours while portions of the respective surfaces are the same. The base 94 of the console module 18—along with the base of any other primary module configured for attachment or installation at the first and second locations 14, 16—may therefore include a feature to accommodate differences in the shapes of the mating surfaces 58, 104. In this case, the console module base 94 includes a cutout 108 complementary in shape to the ledge 106 of the seat frame 24.

The illustrated armrest 96 has a cushioned top and may be hingedly attached to the base 94 to selectively open and close an underlying console storage area. The cushioned top may be horizontally adjustable to move forward of the illustrated position and/or may be hinged to a base of its own to provide access to an underlying storage area. As shown in subsequent figures, the armrest 96 may house a deployable and stowable table that rests on the handle 102 when deployed to provide a working surface for vehicle occupants. The cupholders 98 (FIG. 3) may be powered to heat or cool containers placed in the cupholders and may be provided as part of a submodule that is removable from the console module and can be installed in a powered accessory module. The cavity 100 is partly defined by an inclined surface 110 suitable for supporting the back side of a portable electronic device (e.g., a smartphone or tablet) with the screen tilted upward toward the eyes of vehicle occupants. In some embodiments, the inclined surface 110 is a wireless charging surface. The handle 102 has multiple purposes, such as providing a location a user can grasp the console module 18 to remove it from the base 12 or seat frame 24 by pulling upward on the handle and install the module by pressing down on the handle after the rear of the module is resting at the desired location 14, 16. As noted above, the handle 102 can also provide support for a deployable working surface. In the illustrated example (FIG. 3), surfaces of the handle 102 are at the same angle of inclination as the inclined surface 110 of the cavity 100, which facilitates support of larger electronic devices such as tablets. In some examples, the console module 18 does not include the cupholders 98, cavity 100, wireless charging surface 110, and/or handle 102 and may not be a powered module. For example, the console module 18 may simply include a base 94 and an armrest 96 that pivots to open and close an underlying storage area.

In the example of FIG. 3, a storage bin accessory module 30a is installed at the third module location 26 forward of the tunnel 22 of the base 12. The overall length of the console module 18 is greater than the length L3 (FIG. 2) of the first location 14 such that a portion of the console module extends over the third location 26 with portions of the console module and the accessory module 30a overlapping each other forward of the tunnel 22. The same situation arises when the console module 18 is installed at the second location 16 while an accessory module 30 is installed at the fourth location 28 rearward of the tunnel 22.

Referring again to FIG. 4, the second module location 16 is provided by a seat pan of the seat frame 24. The seat pan is a portion of a seat frame 24 that supports the seat bottom of a vehicle seat, which supports most of the weight of a seated occupant. The seat frame 24 may include a different structural portion supporting the backrest of the respective vehicle seat. The seat bottom of all three seats of the second row of seating may be provided by identical seat cushion modules 20. Also visible in FIG. 4 is the receptacle 78 at the rear end of the tunnel 22 for receiving one end of an accessory module.

FIGS. 5-7 respectively illustrate the seat cushion module 20 of FIG. 1 installed at the second location 16 in the second row 38 of seats, at the first location 14 in the first row 36 of seats in a forward configuration, and at the first location 14 in a backward configuration. As with the console module 18, at least a portion of the bottom surface of the seat cushion module 20 is complementary in shape with the first mating surface 58 at the first location 14 (FIGS. 6 and 7) and with the second mating surface 104 at the second location 16. As with the console module 18, the seat cushion module 20 includes a cutout 108 complementary in shape to the ledge 106 of the seat frame 24. Due in part to the transition between the horizontal and inclined portions 62, 66 of the first mating surface 58 being near the longitudinal center of the first location 14, the seat cushion module 20 fits into the first location in the forward configuration of FIG. 6, in which the seat cushion module has the same orientation as installed at the second location 16, and in the backward configuration of FIG. 7, in which the seat cushion module is rotated 180 degrees about a vertical axis. The forward configuration of FIG. 6 is useful in conjunction with the anchors 80 for securing a rear-facing child safety seat in the first row of seats at an elevated position, as shown in subsequent figures. The backward configuration is useful as an additional rear-facing seat when the vehicle is not moving, as also shown in subsequent figures. Other types of modules, such as modules having the functionality of the subsequently discussed accessory modules, may be configured for installation or attachment at the first and second locations 14, 16 by having a base or bottom that is sized and shaped in the manner of the console and seat cushion modules 18, 20.

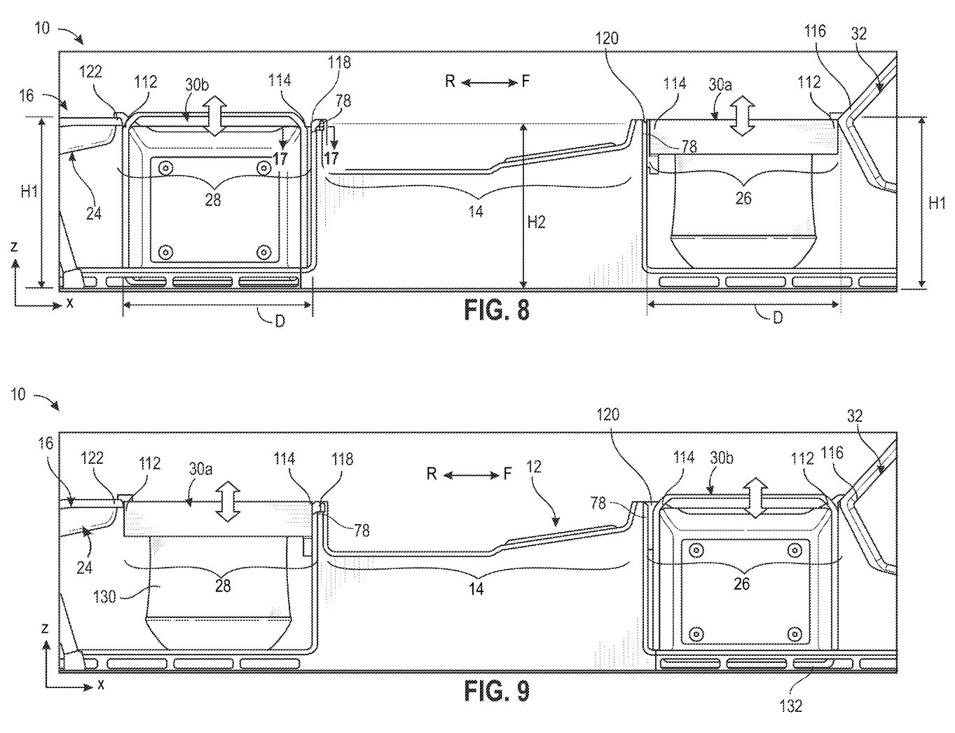

FIG. 8 is a side view of the vehicle interior system 10 with two accessory modules 30a, 30b removably attached at respective third and fourth module locations 26, 28. The third location 26 is forward of the first location 14, and the fourth location 28 is between the first location 14 and the second location 16. The third location 26 is adjacent the tunnel 22 between the first location 16 and the front portion 32 of the base 12. The fourth location 28 is adjacent the tunnel 22 between the first row of seats and the second row of seats.

Opposite first and second ends 112, 114 of each accessory module 30a, 30b are supported at each location 26, 28 by longitudinally spaced supports, including front supports 116, 118 and rear supports 120, 122. Specifically, the first end 112 of the accessory module 30a is supported by a front support 116 at the third location 26, the second end 114 of the accessory module 30a is supported by a rear support 120 at the third location 26, the first end 112 of the accessory module 30b is supported by a rear support 122 at the fourth location 28, and the second end 114 of the accessory module 30b is supported by a front support 118 at the fourth location 28. Each of the front support 116 at the third location 26 and the rear support 122 at the fourth location 28 is configured to mate with and support the first end 112 of the respective accessory module 30a, 30b, while each of the rear support 120 at the third location 26 and the front support 118 at the fourth location 28 is configured to mate with and support the second end 114 of each accessory module 30a, 30b. In this example, the front support 116 at the third location 26 is provided by a transversely extending lip of the front portion 32 of the base 12 (see also FIG. 2), and the rear support 120 at the third location 26 is provided by the receptacle 78 along the front of the tunnel 22. The front support 118 at the fourth location 28 is provided by the receptacle 78 along the rear of the tunnel 22, and the rear support 122 at the fourth location 28 is provided by the transversely extending lip 72 of the seat frame 24 (FIG. 4). A longitudinal distance D between the front and rear supports 116, 120 at the third location 26 is the same as the longitudinal distance D between the front and rear supports 118, 122 at the fourth location 28. Additionally, the height H1 of the supports 116, 122 for the first end 112 of each accessory module 30a, 30b is the same, and the height H2 of the supports 118, 120 for the second end 114 of each accessory module 30b, 30a is the same.

In this example, the first end 112 of each accessory module 30a, 30b has a different configuration than the second end 114 for mating with the respective supports 116-122 such that each module must be rotated about a vertical axis to be installed at the other of the locations 26, 28. FIG. 9 illustrates the two accessory modules 30a, 30b of FIG. 8 with their locations 26, 28 switched such that the first end 112 of accessory module 30a is a rear end supported by rear support 122, the second end of accessory module 30a is a front end supported by front support 118, the first end 112 of accessory module 30b is a front end supported by front support 116, and the second end of accessory module 30b is a rear end supported by rear support 120. In other examples, the ends of the modules 30a, 30b and the respective supports 116-122 are all configured to mate so that the modules can be oriented in either direction. The particular supports 116-122 and associated mating features of the accessory modules 30 illustrated in the figures and described here are only examples. Protrusions and receptacles can provided on opposite components, for example, and other types of supports and other shapes of mating surfaces can be employed.

The illustrated accessory modules include a storage bin module 30a and an insulated storage module 30b. Each module is removably attachable at each location 26, 28 by lowering the respective module into place with ends 112, 114 of the module aligned with appropriate supports 116-122 until complementary surfaces of the module ends are mated together. Each accessory module 30 is either a powered module configured to receive power from the base 12 or an unpowered module. For example, the illustrated insulated storage module 30b may include a thermoelectric device (TED) to heat and/or cool the interior of the module.

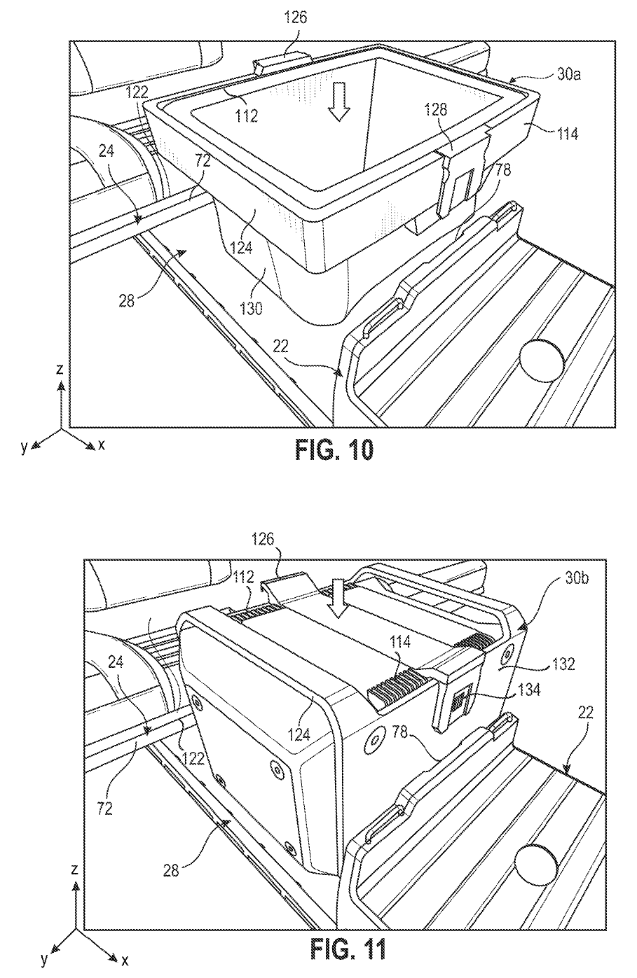

FIGS. 10-14 illustrate non-limiting examples of accessory modules 30. FIGS. 10 and 11 are respective perspective views of the storage bin module 30a and insulated storage module 30b of FIGS. 8 and 9 during installation at the fourth location 28. Each of these modules 30a, 30bincludes a frame 124 carrying a hook 126 at the first end 112 and a protrusion 128 at the second end 114. Each hook 126 and protrusion 128 is at the transverse center of the frame 124. The hooks 126 are configured to mate with the support 122 provided by the lip 72 of the seat frame 24 and with the support 116 at the front of the third location (FIGS. 8 and 9), and the protrusions 128 are configured to mate with the receptacles 78 at each end of the tunnel 22.

The frame 124 of the storage bin module 30a is rectangular in an x-y plane with the hook 126 and protrusion 128 on respective front and rear frame members that are interconnected by transversely spaced side frame members. The interior of the module 30a is defined by one or more fabric walls 130 suspended from the frame 124, in this example. As shown in FIG. 9, the frame 124 and the fabric walls 130 are all suspended from the supports 118, 122 such that the module does 30a not contact the central portion of the bottom of the base 12, which ensures that the module can be fully installed without interference between the bottom of the module and the base 12. One or more of the walls defining the interior of the storage bin module could be rigid walls.

The frame 124 of the insulated storage module 30b in FIG. 11 is also rectangular with the hook 126 and protrusion 128 on respective front and rear rigid wall members 132 that are interconnected by transversely spaced handles at the top and another rigid wall member at the bottom (labeled in FIG. 9). A hollow interior of the module 30a is defined by one or more insulated walls within the frame 124, in this example, with the top wall hinged to form a door. As shown in FIG. 8, the frame 124 is suspended from the supports 118, 122 such that the module 30b does not contact the central portion of the bottom of the base 12, which ensures that the module 30b can be fully installed without interference between the bottom of the module and the base 12. Where the module 30b is a powered module, external connectors 134 may be provided as part of the protrusion 128 to provide an electrical connection between the module 30b and the base 12 and/or to help magnetically attach the module 30b to the base 12 as discussed further below.

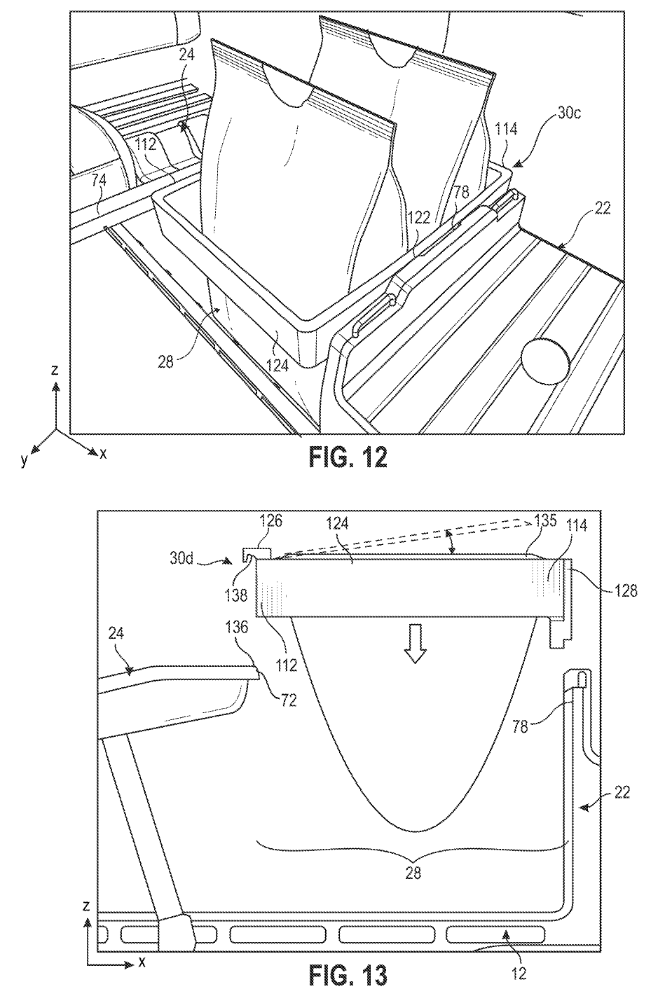

FIGS. 12 and 13 are respective views of a frame module 30c and a refuse module 30d, which are variants of the unpowered storage bin module 30a of FIG. 10. Each module 30c, 30dincludes the same frame 124 as the storage bin module 30a with the same hook 126 and protrusion 128 at the respective first and second ends 112, 114. The frame module 30c is illustrated in the fully installed position to illustrate its utility as a side support for cargo such as groceries to prevent them from toppling over. This module 30cis essentially the same as the storage bin module 30a without the fabric walls 130.

The refuse module 30d of FIG. 13 is illustrated in side view during installation to better illustrate the hook 126 and protrusion 128. This module 30d includes the same frame 124 as the other unpowered modules 30a and 30c and additionally includes a lid 135 hinged at one end of the frame. The frame 124 may be configured to releasably support a disposable bag beneath the frame as shown. The lip 72 along the front edge of the seat frame 24 has an upward facing mating surface 136 complementary in shape with a downward-facing mating surface 138 of the hook 126. The hook 126 may snap-on to the seat frame 24 (or on the front support 116 at the third location of FIG. 8). The protrusion 128 extends outward from the frame 124 at the second end 114 by the depth of the receptacle 78 and from the top of the frame to a location below the frame. The protrusion 128 and receptacle 78 are discussed further below.

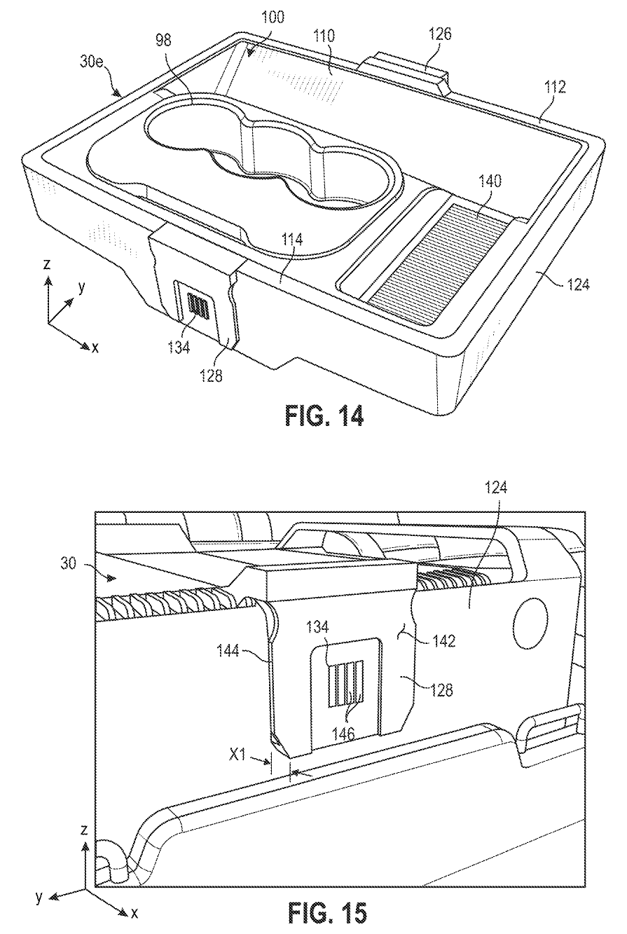

FIG. 14 is a holder module 30e illustrated in an orientation for installation at the third location 26 of the previous figures. As with the other accessory modules 30a-30d, this module includes a frame 124 with the same hook 126 and protrusion 128 at the first and second ends 112, 114. All sides of the frame 124 are interconnected by a continuous top surface that includes multiple recesses, including a cavity 100 similar to that of the console module of FIG. 3 and a recess containing a submodule with cupholders 98 similar to those of FIG. 3. The module 30emay be a powered module with connectors 134 to provide an electrical connection between the module 30e and the base 12 and/or to help magnetically attach the module to the base. The powered version of the module 30emay include a wireless charging surface along the inclined surface 110 of the cavity 100 and/or heated or cooled cupholders 98. Another horizontal recess 140 may also include a horizontal wireless charging surface. As with the other accessory modules, the holder module 30e can also be installed at the fourth location 28 between the first and second rows of seats by rotating it about a vertical axis. In some embodiments, the holder module 30e does not include a frame and is configured to be installed in a frame module 30cto enable attachment to the system 10 and/or and electrical connection with the base 12.

Referring again to FIG. 1, the accessory module 30 illustrated at the third location 26 is a file organizer module which is similar in construction to the frame 124 of the insulated storage module 30b of FIG. 11, with rigid front and rear wall members 132 interconnected by a bottom wall member and transversely space handles at the top. The hook 126 and protrusion 128 are the same as those of the other accessory modules. Other types of accessory modules with other functions are possible within the same modular framework. Other illustrative unpowered accessory modules include a storage cabinet module, with rigid walls and one or more shelves inside, a foot rest module, and a tray module—similar to the frame module 30c with a rigid wall spanning the frame 124. Powered accessory modules may include an infotainment module with a screen for viewing programs or navigation routes, for example, or a power module configured with multiple different ports (USB-A, USB-C, mini-USB, indoor AC plugs, etc.) for recharging or powering portable electronic devices such as phones and laptop computers. Such power ports may be included on any of the above-described primary or accessory modules.

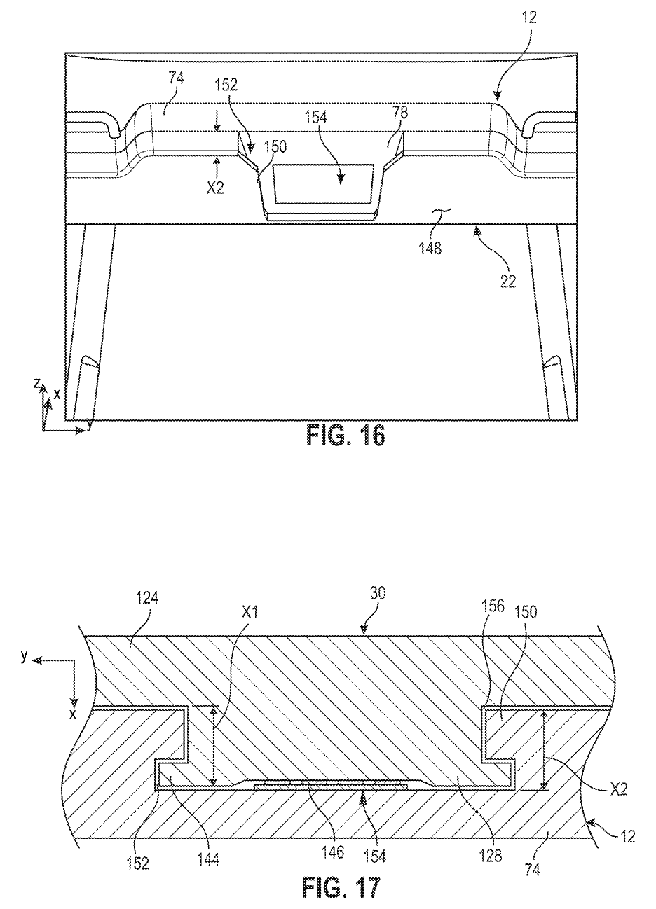

FIG. 15 is an enlarged view of a longitudinal end face of a protrusion of an accessory module 30, and FIG. 16 is an enlarged view of a receptacle 78 of the base 12 that is configured to receive and support the protrusion of FIG. 15. The protrusion 128 extends longitudinally away from the frame 124 of the module 30 by a distance X1, where a longitudinal end face 142 of the protrusion is defined. A pair of wings 144 at the longitudinal end face 142 extend in opposite transverse directions away from the transverse center of the protrusion 128. Each wing 144 ends in a concave curve shape at the top end and a chamfer at the bottom end. The chamfers serve as lead-in locators when the module 30 is being installed. Surfaces of the wings 140 may be mating surfaces forming an interface with mating surfaces of the receptacle 78 receiving the protrusion 128.

The optional connectors 134 in a recess of the end face 142 may include a plurality of individual terminals 146 serving as positive and negative terminals for a DC power source and/or control terminals interconnecting the module 30 with a system controller. Optionally, one or more of the terminals 146 may be magnetic or ferromagnetic for releasable magnetic attachment to a ferromagnetic or magnetic material of a mated receptacle 78. For example, one of the illustrated terminals 146 may be a magnet or the protrusion may include an embedded magnet or ferromagnetic material.

The receptacle 78 of FIG. 16 is formed as a recess in the transversely extending lip 74 along the top of the rear end of the tunnel 22. The receptacle 78 is formed into a longitudinal end face 148 of the lip 74 with a longitudinal depth X2. A pair of ribs 150 extend in opposite transverse directions toward the transverse center of the receptacle 78. Each rib 150 ends in a chamfer at the top end and defines a vertical channel 152 along each transverse side of the recess. The wings 144 of the protrusion 128 of FIG. 15 are received in these channels 152 during installation of the accessory module 30. While not shown explicitly here, a face of a central region 154 of the receptacle 78 may include electrical power or communication terminals in alignment with the terminals 146 of the protrusion 128 such that, when the module 30 is installed, electrical contact is made between opposing terminals. The electrical connections so-formed are concealed electrical connections. This region 154 may also house a magnet or ferromagnetic material to form a magnetic attachment with a corresponding ferromagnetic material or magnet of the protrusion 128. Magnetic components may be included at the protrusion 128 to form a magnetic attachment between any accessory module and each receptacle 78, even when the accessory module 30 is not a powered module.

FIG. 17 is a cross-sectional view of a receptacle 78 of the base 12 mated with the protrusion 128 of an installed powered accessory module 30, taken from FIG. 8. FIG. 17 includes reference numerals indicated features from the previous figures and illustrates the wings 144 of the protrusion 128 received in the channels 152 of the receptacle 78. The ribs 150 of the receptacle 78 are also received in channels 156 defined between the frame 124 and the wings 144 of the protrusion 128. This mutual interlocking of features constrains the installed module 30 in the longitudinal and transverse directions, while gravity and an optional magnetic connection constrains the module in the vertical direction.

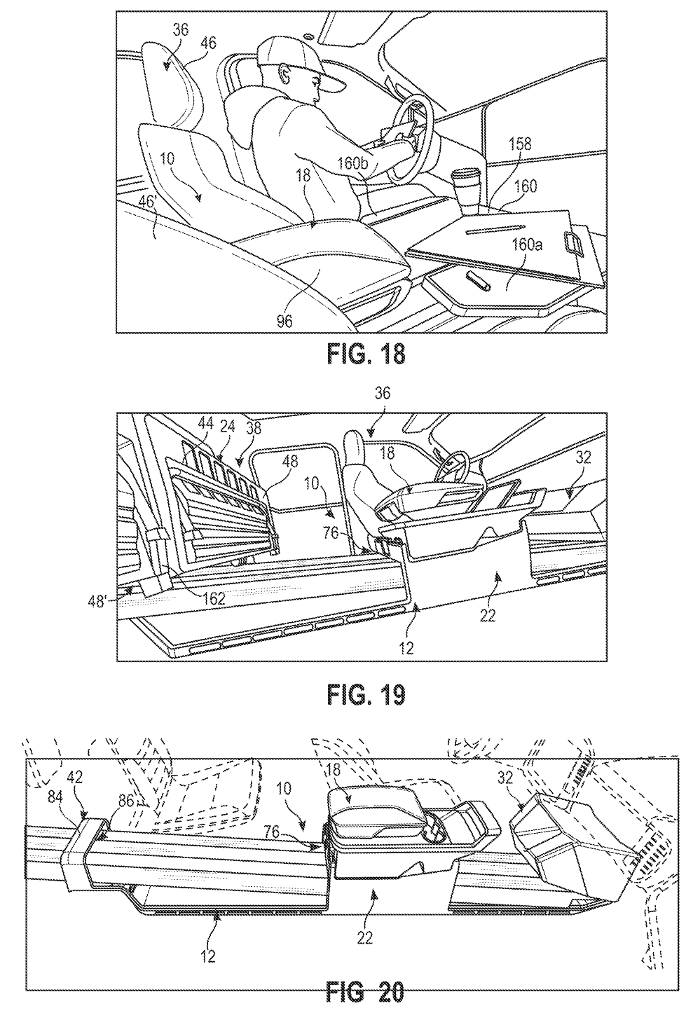

FIGS. 18-32 illustrate various different configurations of the above-described vehicle interior system 10 as employed by vehicle occupants in different use cases.

In FIG. 18, the system 10 is in use as part of a mobile office in the vehicle passenger compartment. The system 10 is configured as in FIG. 1, which may be a default configuration similar to conventional vehicle interiors in which the console module 18 is installed between first and second seats 46, 46’ in a front row 36 of seats and the seat cushion module 20 is installed in the second row of seats. As shown in FIG. 1, a file organizer module 30 is installed at the third location 26, forward of the console module 18. As noted above, the system 10 may include a deployable working surface 158. In this example, the working surface 158 is provided by an extendable and retractable folding table including a main table 160 and a pair of side tables 160a, 160b. The side tables 160a, 160bpivot about a longitudinal axis to fold on top of the main table 160. When folded, the table can slide longitudinally into and out of a base portion of the armrest 96 (e.g., on side rails). FIG. 18 shows the table extended from the armrest 96 with the side tables 160a, 160b folded out to extend the horizontal working surface 158 of the main table 160. A distal end of the table 160 may be supported by the handle 102 (FIGS. 3 and 4) of the console module 18.

In FIGS. 19 and 20, the system 10 is in use hauling extra-long cargo, such as 8- or 12-foot lumber. Referring to FIG. 19, the vehicle is a pick-up truck in this particular example, and the interior system 10 is configured with no accessory modules installed and only one primary module installed, which is the console module 18. Here, the second or rear row 38 of seats is provided by a split-bench seat assembly in which the first seat 48 and center seat 44 share a seat frame 24 and the second seat 48’ has its own seat frame. The bottom portion (i.e., the seat pan) of each seat frame 24 is configured to fold up vertically to lie against respective seat backs. Support legs 162 of the seats also fold against the bottom of the seat frames 24. As noted above, and with reference to FIG. 20 the tunnel 84 at the rear portion 42 of the base 12 is positioned below the seatback of the center seat 44. In this case, the tunnel 84 abuts the rear wall of the passenger cabin and is aligned with an associated passage formed through the front wall of a bed of the truck. This configuration permits extra-long cargo to be loaded into the truck bed from the exterior of the vehicle by passing an end of the cargo through the passage in the front wall of the truck bed, through the passage 86 of the rear tunnel 84 of the base 12 of the system, through the passage 76 of the tunnel 22 in the front row 36 of seats, all the way to the front portion of the base, in front of the front row of seats. In some embodiments, the passage 86 of the rear tunnel 84 of the base 12 may be integral with the passage through front wall of the truck bed. For example, the tunnel 84 of the rear portion 42 of the base may extend through the rear wall of the passenger cabin and through the front wall of the truck bed. The vehicle could also be a sedan or an SUV with the cargo extending into a trunk or other storage space behind the second row 38 of seats. FIG. 19 also shows the console module 18 in use as a support and/or wireless charger for a tablet computer.

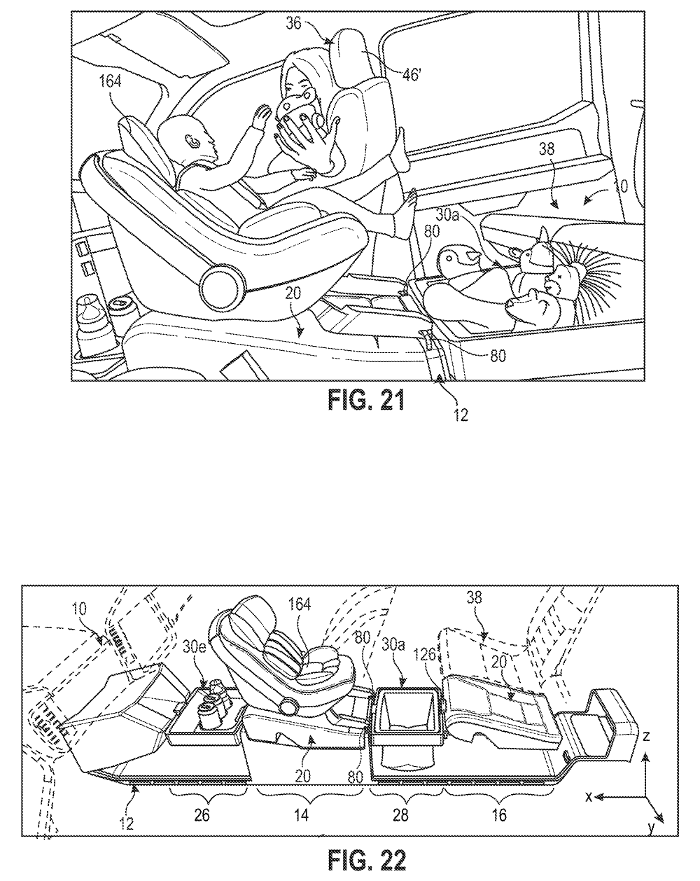

In FIGS. 21 and 22, the system 10 is in use by a family with small children. In this example the system 10 is configured with two seat cushion modules 20—one at the first location 14 in the first row 36 of seats and one at the second location 16 in the second row 38 of seats—along with a powered holder module 30e at the third location 26 and a storage bin module 30a at the fourth location 28. The hook 126 of the storage bin module 30ais placed on the lip 72 of the seat frame 24 before the seat cushion module 20 is installed in the second row 38 of seats. The anchors 80 are Isofix anchors and a rear-facing child safety seat 164 is secured on the front seat cushion module in the same manner it would conventionally be installed in the second row 38 of seats. This configuration is unconventional at least because vehicles equipped with bucket seats in the front row 36 are typically unable to accommodate a child safety seat 164 in the front row, particularly a rear-facing child safety seat. In this configuration, a parent in the front row 36 of seats does not have to turn around or climb to the back seats to see the child. Indeed, in a rear-facing safety seat in the second row of seats, the parent and the child are not able to see each other, which is a common source of stress for parents and children alike. The storage bin module 30ais shown in use holding children’s toys, and the powered holder module is in use holding, with optional temperature control, the child’s bottle and the front seat passengers’ drinks.

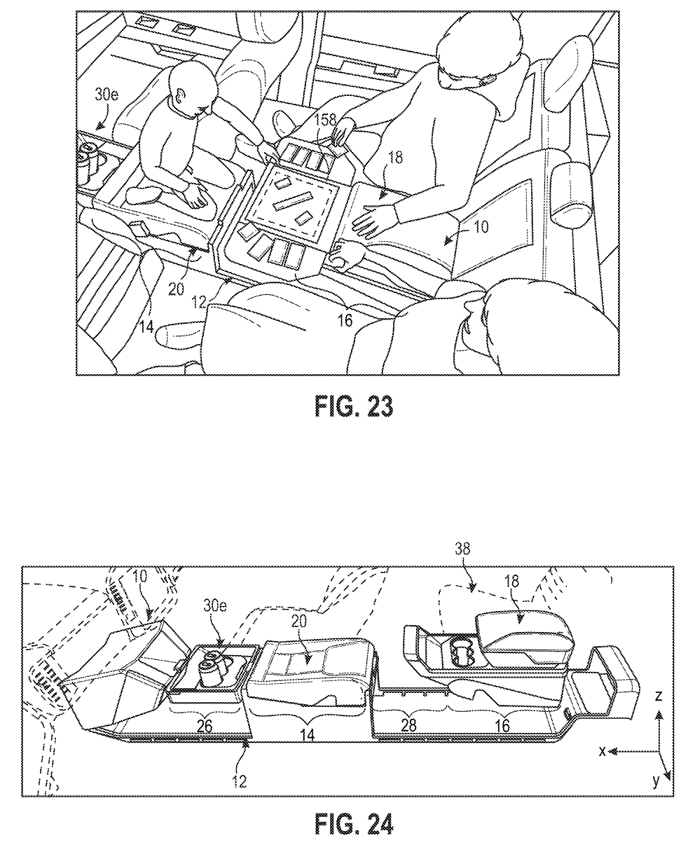

In FIGS. 23 and 24, the system 10 is in use by a family with multiple children entertaining themselves while the vehicle is parked at a rest area or charging station, for example. The system 10 is configured with a seat cushion module 20 at the first location 14, a console module 18 at the second location 16, a powered holder module 30e at the third location 26, and no accessory module at the fourth location. The console module 18 includes the deployable working surface 158 as described above and which is being used as a game surface in the figure. The seat cushion module 20 at the first location 14 is in the backward configuration to provide a rear-facing seating area where the seated passenger can extend their legs into the empty fourth module location. The holder module 30eis shown charging a phone and holding drinks for the vehicle occupants. When the family is ready to resume vehicle travel, the working surface can be stowed in the console module 18, and the console module 18 and seat cushion module 20 can be interchanged to provide a center seat in the second row 38.

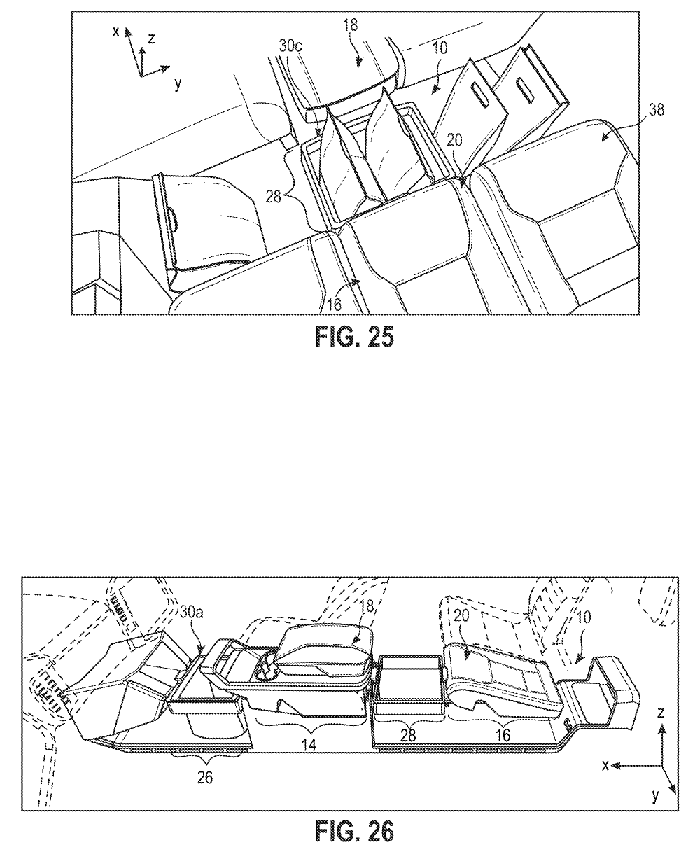

In FIGS. 25 and 26, the system 10 is configured for normal daily with a console module 18 at the first location 14, a seat cushion module 20 at the second location 16, a storage bin module 30a at the third location 26, and a frame module 30c at the fourth location 28. The console module 18 may be a powered module for wirelessly charging phones and other everyday storage. FIG. 25 is a top view of the space between the first and second rows 36, 38 of seats illustrating the frame module 30c in use supporting the sides of loose cargo and with additional cargo outside of the frame module.

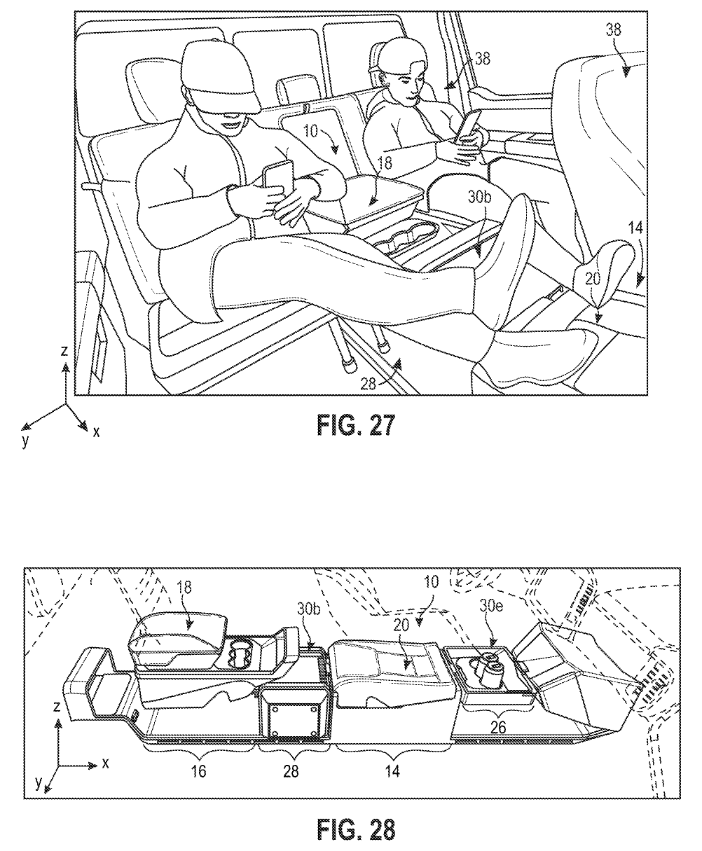

In FIGS. 27 and 28, the system 10 is in use by a family on a long road trip and is configured the same as in FIG. 23 except with an insulated storage module 30b installed at the fourth location 28. The seat cushion module 20 is in use at a foot rest in FIG. 27 and can be installed in the forward configuration of FIG. 27 or the backward configuration of FIG. 28.

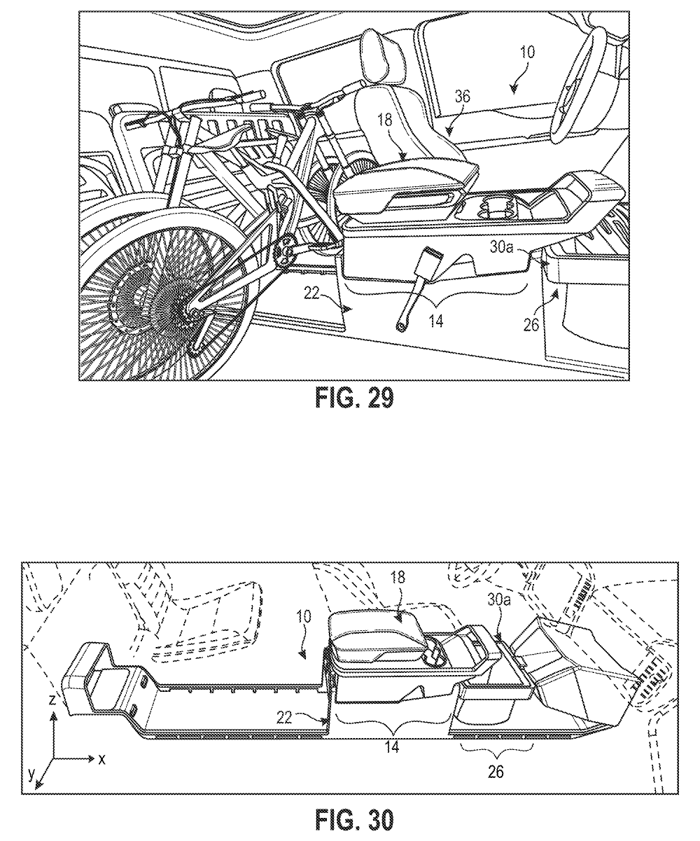

In FIGS. 29 and 30, the system 10 is in use by outdoorspeople and is configured the same as in in FIG. 19 except with a storage bin module 30a installed at the third location 26. The split-bench seat assembly is in the folded configuration in FIG. 29 to accommodate bicycles or other cargo, which is illustrated being secured by straps using anchors at the rear of the tunnel 22 and anchors at the rear portion 42 of the base 12. The storage bin module 30a can hold other outdoor cargo such as the illustrated biking helmets. In some embodiments, the rear end of the console module 18 includes anchors in addition to or in place of the anchors along the rear end of the tunnel.

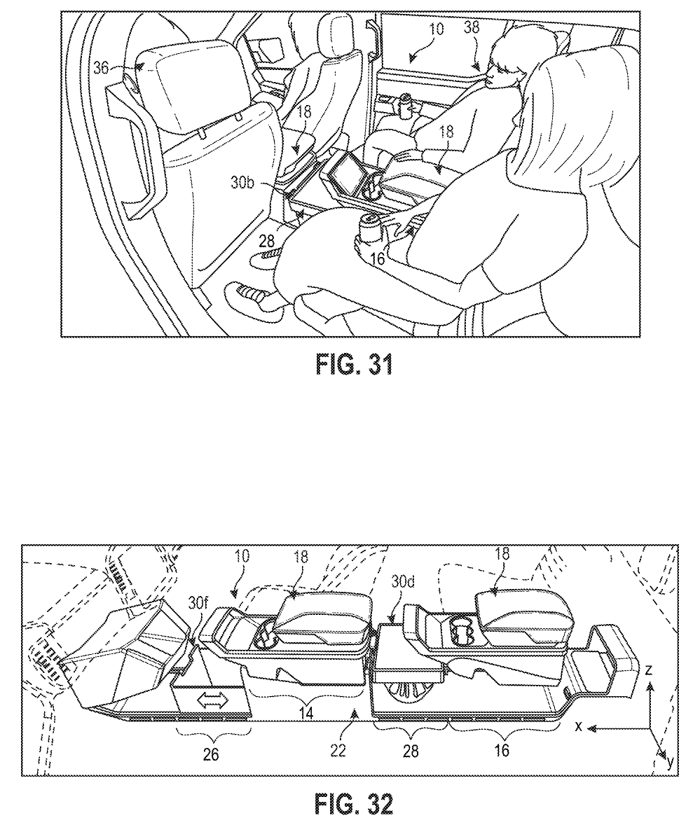

In FIGS. 31 and 32, the system 10 again in use on a long road trip but with a different system configuration. This configuration includes two console modules—one at each of the first and second locations 14, 16—along with a refuse module 30d at the fourth location 28 and a sliding storage bin module 30f at the third location 26. This dual console configuration increases console storage space, cupholder locations, and locations to rest and/or charge portable electronics. The sliding storage bin module does not include the frame 124 of the other accessory modules and is shaped and sized to slide into and out of the passage 76 of the tunnel 22 of the base 12. The sliding storage bin module 30fis guided outside of the tunnel 22 along the opposite ridges 52 of the base 12.

The above-described vehicle interior system 10 can be provided as an OEM or factory-installed option, with the base 12 permanently installed along the floor of the vehicle passenger cabin and, for example, a console module 18 and seat cushion module 20 installed at the first and second locations as a default configuration. Customers may obtain additional console and seat cushion modules 18, 20 if desired to achieve some of the above-described configurations. Customers may also obtain multiple accessory modules to mix and match as desired for their particular wants and needs, either as dealer-installed options or a post-vehicle purchase accessories.

It is to be understood that the foregoing is a description of one or more embodiments of the invention. The invention is not limited to the particular embodiment(s) disclosed herein but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms "e.g.," “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all the following: “A”; “B”; “C”; “A and B”; “A and C”; “B and C”; and “A, B, and C.”

1. A vehicle interior system comprising:
a base extending longitudinally in a vehicle passenger cabin, and
a console module that is removably attachable to the base at a first location in a first row of seats and to a seat frame at a second location in a second row of seats.

2. The vehicle interior system of claim 1, further comprising a seat cushion module that is removably attachable to the base at the first location and to the seat frame at the second location.

3. The vehicle interior system of claim 2, wherein the seat cushion module is configured to be attached to the base at the first location in a forward configuration and in a backward configuration.

4. The vehicle interior system of claim 1, wherein the base comprises a tunnel formed from at least one wall, and wherein the tunnel at least partly defines a longitudinal passage between a first seat of the first row of seats and a second seat of the first row of seats.

5. The vehicle interior system of claim 4, wherein the first location is on top of the tunnel.

6. The vehicle interior system of claim 1, wherein the base comprises a first mating surface at the first location and the seat frame comprises a second mating surface at the second location, and wherein the first mating surface and the second mating surface have different contours.

7. The vehicle interior system of claim 6, wherein portions of the first mating surface and the second mating surface are the same.

8. The vehicle interior system of claim 6, wherein one of the mating surfaces includes an upstanding ledge that the other mating surface does not have, and a base of the console module has a cutout that accommodates the ledge.

9. The vehicle interior system of claim 1, further comprising an accessory module that is removably attachable to the base at a third location forward of the first location and removably attachable to the base at a fourth location between the first and second locations.

10. The vehicle interior system of claim 9, wherein front and rear ends of the accessory module are configured to be supported by respective front and rear supports at each of the third and fourth locations.

11. The vehicle interior system of claim 9, wherein an end of the accessory module is magnetically attachable to the base at the third location and magnetically attachable to the base at the fourth location.

12. The vehicle interior system of claim 11, wherein said end of the accessory module is a rear end when installed at the third location and a front end when installed at the fourth location.

13. The vehicle interior system of claim 9, wherein the accessory module is one of a plurality of accessory modules each having a different function and each being interchangeable with one another at each of the third and fourth locations.

14. The vehicle interior system of claim 1, wherein the base is configured to power installed modules via a concealed electrical connection.

15. The vehicle interior system of claim 1, wherein the base comprises child safety seat anchors at the first location.

16. The vehicle interior system of claim 1, wherein the base comprises a rear portion with a tunnel, the tunnel having a passage that provides access to the vehicle passenger cabin from a rear vehicle storage area.

17. The vehicle interior system of claim 1, wherein the console module comprises an extendable and retractable working surface.

18. The vehicle interior system of claim 1, wherein the base extends along a floor of the vehicle passenger cabin between an instrument panel located at a front of the vehicle passenger cabin and a rear of the vehicle passenger cabin located behind the second location.
